(19) United States
(12) Patent Application Publication
(10) Pub. No.: US 2008/0098447 A1
(43) Pub. Date: Apr. 24, 2008

(54) Programming of informational channels for digital video broadcasting

(76) Inventor: Moshe Yannai, Kadima (IL)

Correspondence Address: THE NATH LAW GROUP, 112 South West Street, Alexandria, VA, 22324, US

(21) Appl. No.: 11/907,961

(22) Filed: Oct. 18, 2007

Related U.S. Application Data
(60) Provisional application No. 60/852,660, filed on Oct. 19, 2006.

(51) Int. Cl. H04N 7/173

(52) U.S. Cl. 725/116

(57) ABSTRACT

a back-end system (BES) capable of generating informational programs, characterized by content and schedule, feedable into a digital video broadcasting (DVB) system connectable thereto, wherein the BES is configured to receive input signals from external sources and, in response, to alter the content and/or the schedule that characterize the program or a component thereof prior to feeding said program to the DVB system, with no need to store the altered program in the BES. The BES generally stores a plurality of slides, comprising images, and corresponding schedules and the generated informational programs generally comprise a sequence of slides selected among the stored slides, in accordance with a respective schedule selected among the stored schedules, wherein altering the program in response to the input signal comprises altering said sequence and/or generating in a slide an image, or an image component distinctive from the corresponding image, or image component, stored in the BES.

### FIELD OF THE INVENTION

This invention relates to digital video broadcasting and, more particularly, to programming informational channels for digital video broadcasting.

### BACKGROUND OF THE INVENTION

In U.S. patent application Ser. No. 09/793,226, submitted by the present applicant, there is described a back-end system (BES), connectable to a digital video broadcasting (DVB) system, for generating one or more digital signals (bit streams) feedable to the DVB system for broadcasting (along other digital signals, which typically may also carry conventional television program channels). Each digital signal output by the BES carries information of a plurality of informational programs, encoded into a plurality of so-called microchannels (or informational channels), which are multiplexed to form the signal bit stream; the encoding and multiplexing are such that each microchannel is individually receivable and decodable by any television receiver generally receptive to signals from the DVB system.

An informational program (henceforth “program” for short) typically consists of a series of slides, each slide containing one or more images and possibly one or more audio components. The image typically consists of a plurality of various components, such as pictures, text, graphics and video clips. Typically the programs are store as data within the BES and are periodically read out from storage, according to a stored schedule; usually each microchannel (henceforth also “channel” for short) is assigned to a plurality of programs, which are fed into it in a sequence determined by the schedule, usually each program in its turn being fed repeatedly. One or more audio components may also be stored separately from the programs and encoded into any specified program in lieu of, or in addition to, slide audio components.

The data for any program are typically loaded, as a whole, into the BES storage from an external source at relatively infrequent occasions (typically measured in weeks or months) but are read out for encoding and broadcasting cyclically or frequently (at periods typically measured in minutes or hours). The broadcast information thus remains relatively unchanged over many cycles.

Often it is desirable or necessary to instantly change some of the presented information. This may be dictated, for example, by external events, such as news events, or by the need to present specific changeable data, such as prices, market quotes or weather. Another needs for such instant changes in data to be presented occurs when there are provided means for feedback from viewers, such as answers to a quiz or voting or ordering a product, as is also known in interactive TV—to which some displayed response is expected. Moreover, instant changes in the programs are usually valid for a limited time, after which the stored, unchanged data may be reverted to for continued broadcasting. Yet another type of instant change that may be necessitated by unexpected events or business considerations is a change in the schedule of any program, including for example immediate broadcasting of a particular program or a particular portion thereof.

It is impractical to provide such instant changes by composing and loading complete suitably modified programs, or even program schedules, into the storage of the BES. Hence it would be desirable and advantageous to provide an enhancement to the BES, in accordance with certain embodiments of the present invention, wherein instant changes to a program can be communicated to the BES and carried out with no need to change any of the stored data.

### SUMMARY OF THE INVENTION

In accordance with certain aspects of the present invention, there is provided a back-end system (BES) connectable to a digital video broadcasting (DVB) system and capable of generating at least one informational program, characterized by content and schedule and feedable into the DVB system, wherein the BES is configured to receive at least one input signal from at least one external source and, in response to said input signal, to alter the content and/or the schedule that characterize the program or a component thereof prior to feeding said program to the DVB system, with no need to store the altered program in the BES.

In accordance with further aspects of the present invention, the BES stores a plurality of slides, comprising images, and corresponding schedules, the BES configured to generate at least one informational program comprising a sequence of slides selected among the stored slides, said sequence generated in accordance with a respective schedule selected among the stored schedules, wherein said altering the program in response to the input signal comprises altering said sequence and/or generating in at least one slide at least one image, or at least one image component, distinctive from the corresponding image, or image component, stored in the BES.

In accordance with further aspects of the present invention, the BES may be further configured to initiate obtaining dynamic data from at least one external source and to use said obtained dynamic data as said input signal. The request for obtaining data and receiving the data may be provided via Internet.

In accordance with other aspects of the present invention, there is provided a back-end system (BES) capable of generating one or more informational programs characterized by content and schedule. The BES comprises a storage configured to store contents and schedules of associated programs; at least one encoder capable of generating programs in video format according to corresponding contents data fed thereto, and a scheduler operatively coupled with the storage and with the encoder and capable of retrieving content and schedule data from said storage and feeding and content data to at least said encoder according to corresponding retrieved schedule data. The scheduler is further configured to receive and interpret at least one input signal from at least one external source, to ascribe the received signal to at least one respective program, and to provide change schedule data and/or add contents data that were comprised in the received input signal to those retrieved from said storage, and/or substitute at least part of contents data retrieved from said storage by contents data that were comprised in the received input signal. These operations to be effected in response to the received input signal prior to feeding the contents data to the corresponding encoder.

In accordance with further aspects of the present invention, the scheduler is further configured to issue to at least one external source communicative with the BES a request for dynamic data, said data, when obtained, to be used as said input signal. This source and the timing of the request may be specified in contents data retrieved from said storage.

In accordance with further aspects of the present invention, the BES further comprises an events storage accommodating a list of predefined events, which specify changes to be provided to the contents and/or schedule data related to a specified program. The scheduler is further configured to detect within said input signal a code configured to trigger at least one event; retrieve from said events storage at least one event corresponding to the detected trigger; and carry out the changes specified in the retrieved event.

In accordance with other aspects of the present invention, there is provided a method of altering at least one program in response to at least one input signal. The method is provided for use with a back-end system (BES) capable of generating one or more informational programs characterized by content and schedule. The method comprises:
(a) receiving at least one input signal from at least one external source
(b) interpreting said input signal so as to obtain:
   i) an identification of the program to be changed;
   ii) an indication of one or more altering operations desired by the external source;
   iii) parameters characterizing the altering operations; and
   iv) contents data or reference thereof to be used for the altering operations;
(c) changing the schedule- and/or contents data of the identified program or a component thereof in accordance with the indicated altering operations, the parameters and contents data thereof resulting said interpreting.

In accordance with other aspects of the present invention, there is provided a method of dynamically changing a specified component of at least one program. The method is provided for use with a back-end system (BES) capable of generating informational programs according to corresponding contents- and schedules data stored therein, said program feedable into a digital video broadcasting (DVB) system. The method comprises:
(a) storing the contents data corresponding to the specified component in an association with at least one location reference to a dynamic data source
(b) detecting said location reference upon retrieving the stored contents data, and sending to the referenced location a request for receiving the corresponding dynamic data;
(c) altering the retrieved contents data by adding or substituting thereof with dynamic data received in response to said request, said altering provided prior to carrying out said generating of the corresponding program.

In accordance with either of the above-mentioned aspects of the present invention, the plurality of altering operations comprises at least one of the following:
(a) substantially immediate inserting at least one new slide, wherein the content of the slide is comprised in the input signal and/or available from an external source by reference comprised in the input signal;
(b) inserting one or more slides in a sequence and at a time specified in the input signal, wherein the content of the slides is comprised in the input signal and/or available from an external source by reference comprised in the input signal;
(c) inserting into at least one specified position in at least one slide one or more specified image elements, wherein the contents of the image elements are comprised in the input signal and/or available from an external source by reference comprised in the input signal; and
(d) inserting one or more slides at times and/or in sequential positions specified in the input signal, wherein the content of the slides is stored in the BES.

In accordance with either of the above-mentioned aspects of the present invention, at least one slide may further include an audio component, and said altering the program in response to the input signal further includes altering or replacing said audio component.

In accordance with either of the above-mentioned aspects of the present invention altering the program may be effected substantially immediately after the reception of respective input signal. Altering a not currently scheduled program may comprise substantially immediate scheduling of the program. The programs may be configured to be distributed over a plurality of channels, each channel carrying one or more programs in sequence, the channels being fed to the DVB system simultaneously in a multiplexed manner.

### BRIEF DESCRIPTION OF THE DRAWINGS

In order to understand the invention and to see how it may be carried out in practice, certain embodiments will now be described, by way of non-limiting example only, with reference to the accompanying drawings, in which:

FIG. 1 is a schematic block diagram of a back-end system of prior art;

FIG. 2 is a schematic block diagram of a back-end system according to a certain embodiments of the present invention;

FIG. 3 is a schematic block diagram illustrating certain data handling features of the back-end system of FIG. 2.

### DETAILED DESCRIPTION OF EXEMPLARY EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention. In the drawings and description, identical reference numerals indicate those components that are common to different embodiments or configurations.

Unless specifically stated otherwise, as apparent from the following discussions, it is appreciated that throughout the specification discussions utilizing terms such as “processing”, “computing”, “calculating”, “determining”, “generating”, “altering” or the like, refer to the action and/or processes of a computer or computing system, or processor or similar electronic computing device, that manipulate and/or transform data represented as physical, such as electronic, quantities within the computing system's registers and/or memories into other data, similarly represented as physical quantities within the computing system's memories, registers or other such information storage, transmission or display devices.

Embodiments of the present invention may use terms such as, processor, computer, apparatus, system, sub-system, module, unit and device (in single or plural form) for performing the operations herein. This may be specially constructed for the desired purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, Disk-on-Key, smart cards (e.g. SIM, chip cards, etc.), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions capable of being conveyed via a computer system bus.

The processes/devices presented herein are not inherently related to any particular electronic component or other apparatus, unless specifically stated otherwise. Various general purpose components may be used in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The terms “instant changes” and “instant altering”, as used in this patent specification, include any kind of alteration of content and/or schedule of one or more programs to be broadcast, with no need to store the altered content and/or schedule in the BES before broadcasting.

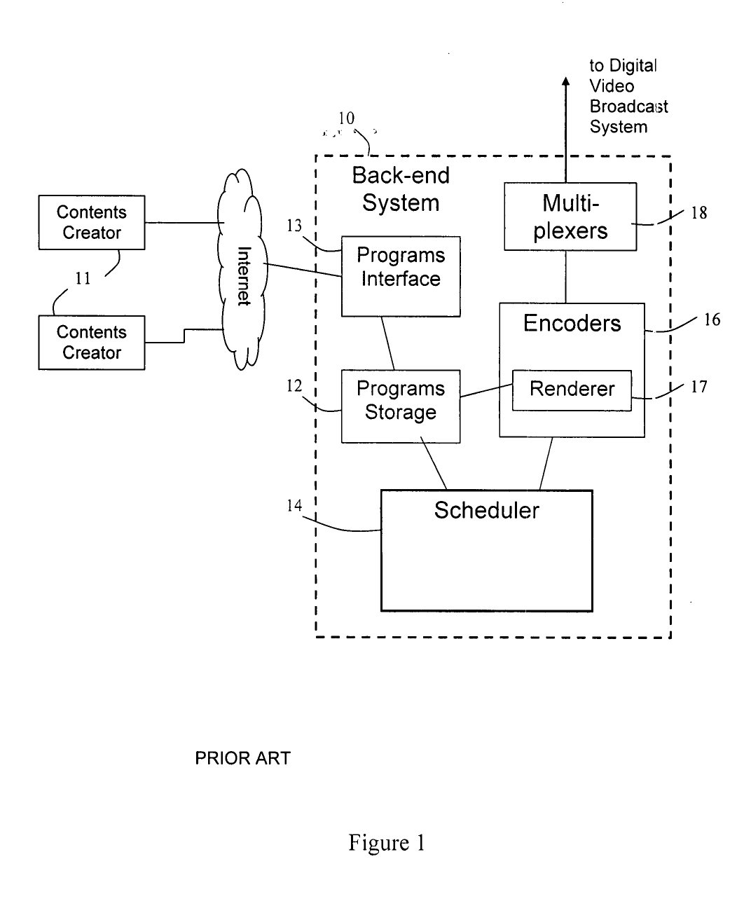

Bearing this in mind, attention is drawn to FIG. 1 presenting a typical Back-End System (BES) of prior art 10. It is shown to include, as major components—
a Programs Storage facility 12, in which there are stored, for each informational channel (henceforth “channel” for short), one or more programs, each program consisting of slide data, defining a plurality of slides, and schedules for broadcasting them over the respective channel;
a Scheduler 14, to be explained herebelow;
one or more Encoders 16, which convert slide data, as obtained from storage, into a corresponding digital signal (or bit stream), each Encoder usually including a Renderer 17, which converts graphical data of any slide from a descriptive format into a raster-oriented format; and
one ore Multiplexers 18, which combine bit streams of the various channels into a single multiplexed bit stream, to be fed to the broadcast system.

Slide data may include visual data (such as pictures, video clips, graphics and text) and audio data. Audio data may be fed into the encoders also from other sources, as explained below. Slide data for each channel are alternately assigned to various encoders as they become available, but the resultant signals are assembled in sequence, to become that channel's bitstream. The encoders and the multiplexer are preferably, but not necessarily, capable of high degree of data compression, as described for example in U.S. patent application Ser. No. 09/793,226.

Programs to be stored into Programs Storage facility 12 may be received via any suitable means, including, for example:
via a local network or direct connection to a computer,
by means of a transportable medium (such as a magnetic- or optical disc or a flash memory) or
via the Internet (which is the means shown in the configuration of FIG. 1). The programs for storing may be received by means of a Programs Interface 13, which is usually included in BES 10 and which communicates with a plurality of sources that provide suitable program. A program may be composed at any of the sources by any suitable means, including, for example, a specialized software package termed Contents Creator, shown illustratively as blocks 11. It is noted that such storing operation, with respect to any program, usually occurs relatively infrequently—that is, once for a large number of repeated broadcasting of the program and in no particular time relation to the schedule of the program.

In essence, the back-end system of prior art operates generally as follows: The scheduler obtains from storage the schedule of programs for each channel and accordingly causes slide data, sequentially for each program, to be transferred from storage to an encoder. The latter renders corresponding images and encodes the resultant data into a digital signal according to an MPEG standard; it also integrates therein any corresponding audio data. The signals of the various channels are buffered and, under control of the scheduler, are passed on to the multiplexer, where they are time-multiplexed into a single multi-channel bit stream; the latter is fed as input to the digital video broadcast (DVB) system. In certain configurations a single back-end system may output a plurality of multi-channel bit streams, each carrying a plurality of informational channels. It is noted that each of the multi-channel bit streams thus input are treated by the DVB system in the same manner as a regular single-channel video bit stream. It is also noted that each of the informational channels is individually selectable, receivable and decodable by a receiver of the system. More information about BES of prior art may be found, for example, in U.S. patent application Ser. No. 09/793,226. The full content of this application is incorporated by reference herein where appropriate, for appropriate teachings of additional or alternative details, features and/or technical background.

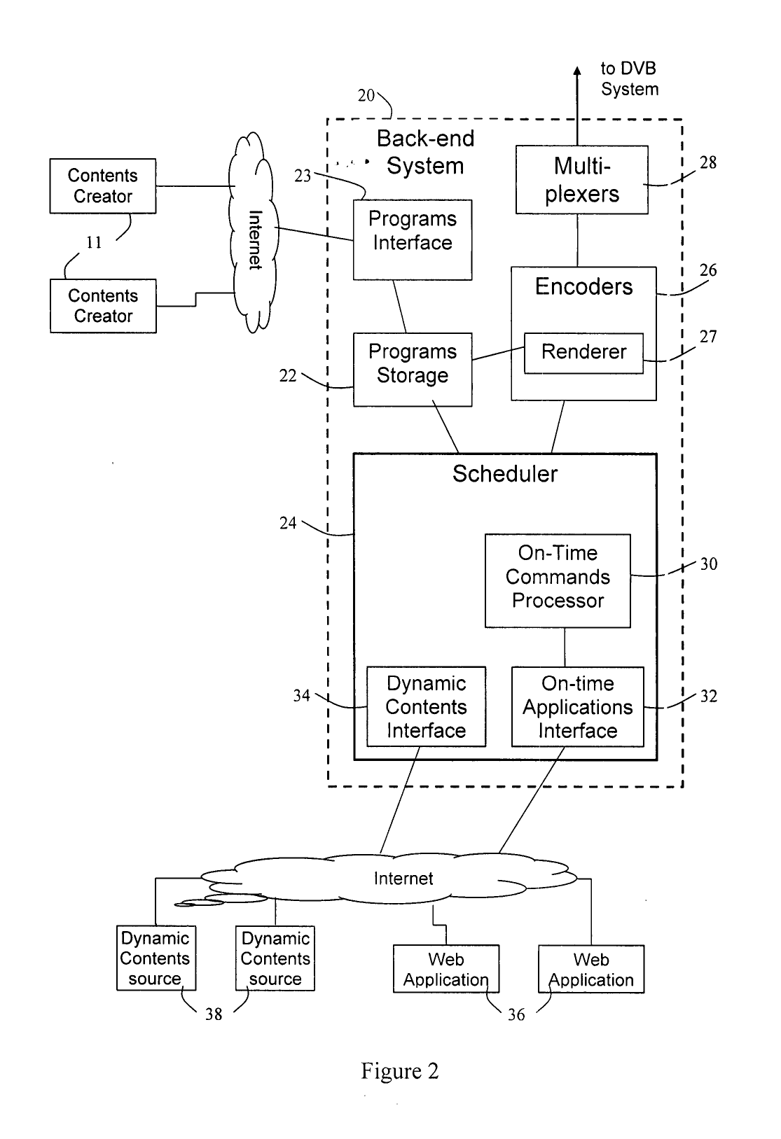

FIG. 2 presents, in block diagram, an exemplary embodiment of a BES 20 according to the present invention. It is seen to resemble that of FIG. 1 and includes, in essence, all its components, except that the Scheduler 24 now includes additional components and is modified to have enhanced functionality, as will be explained herebelow. All the other components—particularly Program Storage 22, Programs Interface 23, Encoders 26, Renderers 27 and Multiplexers 28—are essentially similar, in structure and function, to their counterparts in the BES of FIG. 1. The encoders and the multiplexer are preferably, but not necessarily, capable of high degree of compression, as described for example in U.S. patent application Ser. No. 09/793,226.

As in prior art, the back-end system of the present invention is operative to reed into the DVB system one or more bit streams, each carrying a plurality of informational channels (also referred to as virtual channels or micro-channels and henceforth referred to briefly as channels), each channel carrying a sequence of programs, each program consisting of a series of audio-visual slides and possibly an audio stream.

Unlike prior art, however, the back-end system (BES) of the present invention also includes facilities for receiving input signals, carrying commands related to required instant changes in contents and schedules of programs to be broadcast, as well as facilities for providing the corresponding change. Altering the content of a slide may include changing an entire image or a portion thereof, e.g. text, or superposing a small image or a video clip, e.g. within a small window, or moving graphical components of an image, etc.; it may also include adding or changing audio contents. Altering the schedule of a program may include changing the sequence of certain slides or changing the duration of a slide or adding a new slide or eliminating, a slide.

The input signals may be originated at various places and by various agents, including program sponsors, market- or sales agents, government agencies, etc.; they may possibly be dependent from, or occur as a result of, actions or signals from program viewers or other operators. They may be communicated to the back-end system via any suitable transmission media, including land-line or cellular telephone network, the Internet, a satellite channel or a return channel in a video cable system, and may be in any acceptable format—as files or as streaming data—and in accordance with the transmission means (e.g. TCP/IP in the Internet). The data carried by such input signals are preferably structured as commands; each command is associated with a particular one of the programs being, or scheduled to be, broadcast. When received by the BES, each command causes a corresponding change to occur in the respective program. That change may have an immediate or delayed (e.g. upon the next-scheduled broadcast) effect and usually, though not necessarily, is valid over a limited duration or during a single cycle of the program.

Scheduler 24 preferable includes an On-time Commands Processor 30, which is operational to receive input signals, which preferably include commands, to interpret them and to accordingly affect schedules and/or contents of the programs on their way to be processed for broadcasting, thus providing the instant changes. It is noted that the instant changes are provided in relative proximity to the time at which an affected program is to be broadcast; this is in distinction to the normal operation of storing programs, or their components, in Program Storage 22 (e.g. by means of Programs Interface 23), which, as noted hereabove, is normally done at times that are relatively remote from each other and from their broadcasting times.

Input signals, including commands, are preferably received through an On-time Applications Interface 32, which also is within Scheduler 24 and which, in turn, communicates through the Internet, using for example the World Wide Web (WWW) protocol, with any number of appropriate agents, such as Web Applications 36, and receives commands therefrom. Such agents typically are operative to compose and issue such commands.

In the exemplary embodiment there are defined certain types of the commands to which the On-time Commands Processor can respond. Each command specifies a target program to which it is to be applied. The typical types of the commands are:
(a) “Immediate slide”: The content of a complete slide is included (or available by reference) and the slide is to be inserted into the program immediately.
(b) “Slides Sequence”: The contents of a series of slides are included (or available by reference) and these are to be inserted into the program in sequence at a time specified in the command.
(c) “Graphics”: Specified graphic image elements (including alphanumeric characters) are to be inserted into specified positions, or within a predefined area, in a specified, currently stored, slide before it is encoded.
(d) “Reschedule”: Insert specified, currently stored, slides into the program at times, or in sequential positions, specified in the command (rather than according to the stored schedule).

A command may generally comprise any of the following elements and/or combinations thereof (or fields):

a program identifier,

an action code,

explicit slide data, i.e. sound- and/or image data,

references to a source of slide data,

time- or sequencing parameters (for rescheduling) and

space parameters (to indicate locations within a slide).

These are explained in what follows.

The action code, typifying the command, specifies the type of change action to be taken with respect to the identified program, such as, for example,
(a) changing the schedule of the program or of one or more specified slides,
(b) interjecting a new slide or a series of slides—either immediately or at specified times or replacing specified slides,
(c) altering any specific slide, by inserting certain components, possibly in replacement of existing ones, into the image, and
(d) switching in background streaming media data (audio and/or video). Explicit slide image data will include, in the case of a new slide, data for a complete image (i.e. an entire screen); in the case of slide alteration, the data will include the image components to be inserted. In any case, the image data may be in a variety of formats, suitable for various image component types, such as raster format (i.e. fully rendered), video and any acceptable graphic description format, including text. Inserted raster images and video clips will generally occupy a widow smaller than the full screen. Graphic descriptions may include codes of predefined graphic elements, such as letters and numbers, icons and symbols; they may also include visual parameters, such as size, color and orientation. The location of the insertion of a component within an image is either predefined (for example, within a certain frame, or window) or specified in the command (see below).

Data source references point to locations in which particular slide data are stored, which data are to be retrieved and inserted in the program. Such a location may be within the BES—either in a special storage unit or in the general (i.e. regular, or static) slide data storage—or it may be entirely external to the DVB system and reachable, for example, via the Internet; in the latter case the reference would usually be in a URL (Uniform Resource Locator) format. It is noted that a location reference in a command would usually be an alternative to inclusion of explicit slide data in the command.

Space parameters specify where, within a slide image, any image component generated from real-time received data is to be inserted. It is noted that the position of an inserted component may alternatively be prescribed within the original (stored) image data.

Time parameters specify the time, or the sequential position in the program, at which a given slide or series of slides is to be inserted into the program; such insertion may be in place of regularly scheduled slides. The inserted slides may come from real-time received media data or from a referenced location, including regularly stored slides (which would otherwise be inserted according to the regular, stored, schedule). Time parameters may also specify the time and duration of broadcasting a whole re-scheduled program.

A command generally comprises a program identifier and an operation code, which typifies the command and specifies the type of change action to be taken. According to its type, a command may also comprise additional elements. Thus, types ‘a’ and ‘b’ include explicit slide data (i.e. sound- and/or image data); type ‘c’ includes codes (or coded descriptions) of image elements, as well as space parameters (to specify locations within a slide); and types ‘b’ and ‘d’ include time- or sequencing parameters (for slide scheduling). Optionally, a command may include a location reference, i.e. a reference to a source of image-, sound- or graphic data, instead of the explicit data; such a reference may be a local file name or a URL to be addressed over the Internet.

Optionally, a list of certain instances of commands may be predefined, as so-called events, and stored within the BES. An additional type of command, called trigger command, would then identify a particular event from the list, to be activated; the command would additionally include only the necessary variable symbolic data, such as text and numbers. An event is thus a predefined change in contents and/or schedule of a program, which is activated by a trigger command. Accordingly there is defined an additional type of a command carried by an input signal, namely:
(e) “Activate event”: Fetch a specified event from storage and accordingly modify a corresponding program; an event is a predefined change in the contents or schedule of a program; it is stored in the BES and, once activated, has an effect similar to that of a regular input command.

In some configurations of the BES there is defined yet additional type of command
(f) “Switch program source”: Select the source for slides- and/or audio data to be encoded into the channel for a specified period or until receiving another “switch program source” command; this will be explained further below.

Operation of the On-time Commands Processor (OTCP) 30 is closely entwined with other operations of Scheduler 24 and generally involves manipulating slide (data that are fed to the encoder 26 to which the target program is assigned; all data thus fed into the encoder are considered to be the “current program”. Operation of the OTCP typically proceeds as follows:
The action code is interpreted and the target program identified.
If a location reference is included, appropriate data are fetched from that location.
In the case of a type ‘e’ command (i.e., trigger command), the corresponding event is fetched from storage and interpreted as though it were the cur Tent command.
In the case of a type ‘d’ command, the current time or the sequential position of currently encoded slides is monitored by the scheduler 24; at the appropriate moments the specified slides are fetched from their regular storage 22 and fed into the encoder.
In the case of a type ‘a’ command, the slide data are fed directly to the encoder immediately following the current slide, following which its corresponding output signal is fed to the Multiplexer 28 to which the corresponding channel is assigned, thus causing it to be broadcast immediately upon completion of encoding.

In the case of a type ‘b’ command, the current time or the sequential position of currently encoded slides is monitored by the scheduler 24; at the appropriate moments the received slide data are fed directly to the encoder and the fetching of slides from storage 22 is suspended until the end of the received sequence.

In the case of a type ‘c’ command, the sequential position of currently encoded slides is monitored by the scheduler 24; when the specified slide is fetched from storage 22, the received graphic data are inserted into the slide data, at the position indicated by the space parameters, and the thus modified data are fed into the encoder.

In a BES of the present invention, the Scheduler typically includes additional components, and is generally adapted, to receive commands and media data from outside, to process the commands and to cause the corresponding changes to occur in the target programs prior to their being processed (in the conventional manner) for broadcasting.

In certain configurations, the BES of the present invention has also a facility for continuously adding image and/or sound data to a sequence of slides of any given program according to data received in a streaming manner from an external agent, as described above for the input commands signal. Such data may include, for example, background music or other audible information, or a window with a still or animated logo, or ticker tape image. An optional type of the input command would cause the BES to switch, or mix, such streaming data into the program over a specified time period.

According to another optional feature in some configurations, the BES of the present invention can initiate obtaining real-time data from external sources, through any of the available communication links (such as the Internet), and to insert such data in any currently running program or slide. Such initiation will typically be triggered by suitable elements built into the program or the slide—for example a URL imbedded in the description of any given slide or in the description of a box within it, sometimes referred to as a “controller”. Data thus requested and obtained, herein referred to as “Dynamic Contents”, may include, for example, various real-time data and material, such as stock prices, auction bids, weather- and travel information, sports- and news events, or any other information that requires periodic or frequent updates.

Those skilled in the art will readily appreciate that the invention is not bound by the configuration of FIG. 2; equivalent and/or modified functionality may be consolidated or divided in another manner and may be implemented in software, firmware, hardware, or any combination thereof.

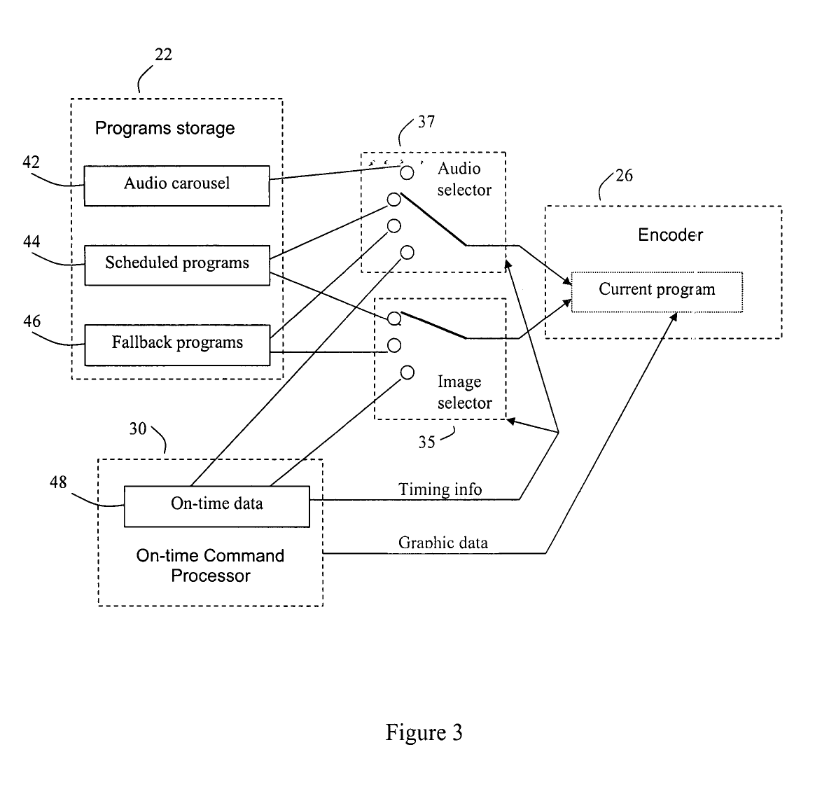

Certain aspects of the operation of OTCP 30 will now be further explained with reference to FIG. 3, which depicts schematically the flow of data to become a current program in an encoder 26. Two refinements are to be noted: (1) data that have heretofore been generally referred to as slide data actually consist of two types, namely image data and audio data; these two types may be handled independently of each other. (2) Program storage 22 contains three groups of data: One group is that of “scheduled programs” 44, which have been the subject of the discussion hereabove; a second group is that of “fallback programs” 46, which are similar in nature to the scheduled programs but are stored or renewed relatively infrequently and, under certain circumstances, serve as an alternate source for broadcasting; the third group is termed “audio carousel” 42 and generally serves to supply background music to any of the programs.

There are two, mutually independent, data selectors—one, 35, for image data selection and the other, 37, for audio data selection; these serve, for each channel, to selectively feed corresponding data from the various sources into the encoder, to become the current program and thus to be encoded and subsequently broadcast. Under normal operation, both selectors are set to feed scheduled programs 44. For some programs, for which no specific audio data are stored, Audio Selector 37 is set to feed data from Audio Carousel 42.

When an input command of type ‘a’ or ‘b’ is received by OTCP 30, it buffers the received on time slide data 48 and Selectors 35 and/or 37 (depending on whether image- and/or audio data of the slides are received) are switched, at the appropriate time, to feed these data, 48, instead of those from the scheduled programs 44. Timing- or scheduling parameters from the command determine the time of switching in and out. In the case of commands of type ‘c’, received graphic data are fed so as to be combined with corresponding slide data from a scheduled program 44 in storage, to become the current program handled by the encoder, as described hereabove.

A command of a type ‘f’ may specify, for any channel, selection of data from Fallback programs 46, rather than from Scheduled programs 44. Selectors 35 and 37 are then switched accordingly and remain so for a specified time or until another type ‘f’ command specifies switching back.

Returning now to FIG. 2, it is seen that Scheduler 24 may include also a Dynamic Contents Interface (DCI) 34, which serves to call from external sources for contents, e.g. image- or audio components, required dynamically in certain slides. DCI 34, is generally communicative with any number of suitable Dynamic Contents Sources 38—particularly over the Internet. Such contents may be transmitted in any suitable format and may include any type of data, such as graphic elements, text, pictures, a video clip or a sound clip.

It is noted that, unlike input commands, which, as discussed hereabove, are sent from external agents (such as Web applications 36)—at times determined by them—and force changes on the relevant programs, dynamic contents are requested by certain codes within a slide whenever such a slide is about to be broadcast (i.e. prior to being encoded); only data that are received in response to such a request are inserted—immediately—into the slide.

In operation, when a slide with dynamic contents is scheduled to be encoded for broadcasting, a special code that indicates dynamic contents, which is imbedded in its data, is detected and a reference address attached to it is extracted and passed to the DCI 34. That reference may be a local file name, where the contents may be stored, or preferably a Uniform Resource Locator (URL). The DCI then sends a download request to that address, receives the data that was sent in response and passes them on, within Scheduler 24, to be added to that slide; if the data are of any visual type, they are inserted into the slide at the position of the dynamic contents code or as indicated by position parameters attached thereto. Note that in some case the latter operational step is somewhat similar to that following the reception of a type ‘c’ input command. If the data are of audio, they may be switched into the audio input of the encoder—e.g. by means of Audio Selector 37 (FIG. 3).

It should be understood that the system according to the invention, may be a suitably programmed computer. Likewise, the invention contemplates a computer program being readable by a computer for executing the method of the invention. The invention further contemplates a machine-readable memory tangibly embodying a program of instructions executable by the machine for executing the method of the invention. In the preferred embodiments, the invention may be implemented with general-purpose components. It is noted, however, that for high performance in certain applications, at least some of the components may need to be realized as special digital hardware components.

Many embodiments, configurations and optional features are possible, in addition to those described hereabove, all coming within the scope of the invention, which is defined by the claims to follow.

1. A back-end system (BES) connectable to a digital video broadcasting (DVB) system and capable of generating at least one informational program characterized by content and schedule and feedable into the DVB system, wherein the BES is configured to receive at least one input signal from at least one external source and to alter the content and/or the schedule associated with the program, or with a component thereof, in response to said input signal with no need to store the altered program in the BES prior to feeding said program to the DVB system.

2. The BES of claim 1 storing a plurality of slides and corresponding schedules, the BES configured to generate at least one informational program comprising a sequence of slides selected among the stored slides, said sequence generated in accordance with a respective schedule selected among the stored schedules, wherein said altering the program in response to the input signal comprises altering said sequence and/or generating in at least one slide at least one image distinctive from the corresponding image stored in the BES.

3. The BES of claim 2, wherein at least one slide further includes an audio component, and said altering the program in response to the input signal further includes altering said audio component.

4. The BES of claim 2, wherein said generation of distinctive image is provided in accordance with data comprised in the input signal.

5. The BES of claim 1, wherein said altering the program is effected substantially immediately after the reception of respective input signal.

6. The BES of claim 5, wherein altering a non-scheduled program comprises substantially immediate scheduling of the program.

7. The BES of claim 1, wherein said input signal is received from said external source via the Internet.

8. The BES of claim 1 further configured to initiate obtaining real-time data from at least one external source and to use said obtained real-time data as said input signal.

9. The BES of claim 1 wherein said altering the program in response to the input signal comprises at least one operation selected from a group comprising:
(a) substantially immediate inserting at least one new slide, wherein the content of the slide is comprised in the input signal and/or available from an external source by reference comprised in the input signal;
(b) inserting one or more slides in a sequence and at a time specified in the input signal, wherein the content of the slides is comprised in the input signal and/or available from an external source by reference comprised in the input signal;
(c) inserting into at least one specified position in at least one slide one or more specified graphic image elements, wherein the content of the slides is comprised in the input signal and/or available from an external source by reference comprised in the input signal;
(d) inserting one or more slides at times and/or in sequential positions specified in the input signal, wherein the content of the slides is stored in the BES; and
(e) combination of at least two operations among a)-d).

10. A back-end system (BES) capable of generating one or more informational programs characterized by content and schedule, the BES comprising:
(a) a storage configured to store contents and schedules of associated programs;
(b) at least one encoder capable of generating programs in video format according to corresponding contents data fed thereto, and
(c) a scheduler operatively coupled with the storage and with the encoder and capable of retrieving contents and schedules data from said storage and feeding said contents data to at least said encoder according to corresponding retrieved schedule data, wherein the scheduler is further configured to receive and interpret at least one input signal from at least one external source, to ascribe the received signal to at least one respective program and to provide with respect to said program at least one operation selected from a group comprising:
i) change schedule data,
ii) add contents data that were comprised in the received input signal to those retrieved from said storage, and
iii) substitute at least part of contents data retrieved from said storage by contents data that were comprised in the received input signal;
said operations to be provided in response to the received input signal prior to feeding the contents data to the corresponding encoder.

11. The BES of claim 10, wherein said scheduler is further configured to issue to at least one external source communicative with the BES a request for real-time data, said data, when obtained, to be used as said input signal.

12. The BES of claim 11, wherein said source and the timing of said request may be specified in a contents data retrieved from said storage.

13. The BES of claim 10, further comprising an events storage accommodating, a list of predefined events specifying changes to be provided to the contents and/or schedule data related to a specified program, wherein said scheduler is further configured to
(a) detect within said input signal a code configured to trigger at least one event;
(b) retrieve from said events storage at least one event corresponding to the detected trigger; and
(c) carry out the changes specified in the retrieved event.

14. The BES of claim 1, wherein the programs are configured to be distributed over a plurality of channels, each channel carrying one or more programs in sequence, the channels being fed to the DVB system simultaneously in a multiplexed manner.

15. For use with a back-end system (BES) capable of generating one or more informational programs characterized by content and schedule, a method of altering at least one program in response to at least one input signal, the method comprising:
(a) receiving at least one input signal from at least one external source;
(b) interpreting said input signal so as to obtain:
i) an identification of the program to be changed;
ii) a plurality of altering operations desired by the external source;
iii) parameters characterizing the altering operations; and
iv) contents data or reference thereof to be used for the altering operations;
(c) changing the schedule- and/or contents data of the identified program or a component thereof in accordance with altering operations, the parameters and contents data thereof resulting said interpreting.

16. The method of claim 15, wherein said receiving at least one input signal is provided via the Internet.

17. The method of claim 15 wherein said plurality of altering operations comprises at least one operation selected from a group comprising:
(a) substantially immediate inserting at least one new slide, wherein the content of the slide is comprised in the input signal and/or available from an external source by reference comprised in the input signal;
(b) inserting one or more slides in a sequence and at a time specified in the input signal, wherein the content of the slides is comprised in the input signal and/or available from an external source by reference comprised in the input signal;
(c) inserting into at least one specified position in at least one slide one or more specified graphic image elements, wherein the content of the slides is comprised in the input signal and/or available from an external source by reference comprised in the input signal; and
(d) inserting one or more slides at times and/or in sequential positions specified in the input signal, wherein the content of the slides is stored in the BES.

18. For use with a back-end system (BES) capable of generating informational programs according to corresponding contents- and schedules data stored therein, said program feedable into a digital video broadcasting (DVB) system, a method of dynamically changing a specified component of at least one program, the method comprising:
(a) storing the contents data corresponding to the specified component in an association with at least one location reference to a dynamic data source
(b) detecting said location reference upon retrieving the stored contents data, and sending to that location a request for receiving the corresponding dynamic data;
(c) altering the retrieved contents data by adding or substituting thereof with dynamic data received in response to said request, said altering provided prior to carrying out said generating of the corresponding program.

19. The method of claim 18, wherein said sending and said receiving is via the Internet.
